(19) United States
(12) Patent Application Publication
(10) Pub. No.: US 2019/0347899 A1
(43) Pub. Date: Nov. 14, 2019

(54) GAMES AND GAMING MACHINES HAVING A CARD BUY/SELL FEATURE

(71) Applicant: Gaming Realms plc, London (GB)

(72) Inventors: Daniel James Lamond, Colchester (GB); Philip Robert John Halston, Colchester (GB); Philip Richard Tuck, London (GB); Michael Buckley, London (GB)

(21) Appl. No.: 16/421,591

(22) Filed: May 24, 2019

Related U.S. Application Data
(63) Continuation of application No. 15/986,052, filed on May 22, 2018.
Application No. 15/986,052 is a continuation-in-part of application No. 15/688,153, filed on Aug. 28, 2017, now abandoned.

(51) Int. Cl. G07F 17/32

(52) U.S. Cl. CPC G07F 17/3244; G07F 17/3272; G07F 17/3216; G07F 17/3293

(57) ABSTRACT

A game and gaming machine include a card buy/sell feature in which cards which are dealt to a player are assigned either a BUY option or a SELL option. In accordance with the BUY option, the player may elect to obtain a replacement card upon payment of a designated price. In accordance with the SELL option, the player may select to sell the card and obtain a replacement card for payment to them of the designated price. The feature may be applied to games such as blackjack and poker to increase the stakes and strategy associated with play of the game.

### CROSS REFERENCE TO RELATED APPLICATION

This application is a continuation of U.S. application Ser. No. 15/986,052, filed on May 22, 2018, which is a continuation-in-part of U.S. application Ser. No. 15/688,153, filed on Aug. 28, 2017, now abandoned. The contents of these prior applications are incorporated by reference as if set forth herein in their entirety.

### BACKGROUND

The disclosed embodiments relate to methods of presenting and playing games and gaming machines configured to present games.

There are a number of core casino games which have remained popular for a long period of time. Among these games are poker and blackjack. Still, the popularity of these games can wain when the games remain unchanged for long periods of time.

Some variations to standard poker and blackjack games have been proposed over time. In many cases, only the simplest modifications or variations to these games that are easy to implement, have been adopted. For example, one simple modification to these games is to offer a side bet and then pay a bonus payout if a particular sub-game result is obtained.

An exciting variation to such games, and one which can be implemented or automated by a technical solution, is desired.

### SUMMARY

Embodiments of the invention comprise games, gaming devices and gaming systems having a card buy/sell feature. In accordance with the feature, a buy or sell option is assigned to each player card, such as each card which is dealt to a player's hand. Each buy or sell option comprises either an option to buy or sell a card at a designated price or value. In the case of a BUY option, the player is given the option to buy a replacement card for the designated card by paying the designated value or price. In the case of a SELL option, the player is given the option to sell the card and obtain a replacement card by being paid the designated value or price.

In one embodiment, the buy/sell feature may be implemented relative to a blackjack game or a poker game, wherein a buy/sell option is assigned to each card dealt to an initial player hand and/or other cards dealt to the player's hand (such as later replacement cards or additional cards dealt to the hand).

In one embodiment, the buy/sell feature is implemented relative to a wagering game where a player is required to place a wager to play the game, such as from a credit balance. In such a configuration, the price which is paid by a player relative to an elected BUY option is deducted from the player's credit balance and the player's credit balance is increased by the price of any elected SELL option.

The features of the invention may be implemented at gaming device which comprise gaming machines or game tables, including where cards are displayed by an electronic video display or where physical cards are dealt.

In one embodiment, although the games include a buy/sell option or feature, the outcomes of the games may be determined in accordance with normal rules. For example, the outcome of a blackjack game having buy/sell options relative to player cards may be determined relative to a final player hand and a final dealer hand (including whether either or both hands went bust).

In a preferred embodiment, the buy/sell feature is implemented by a controller of the gaming machine, table or system. The controller may execute software which implements an algorithm for determining or calculating, in real time as the game is played, whether a BUY or SELL options should be assigned to each card and the associated price for that option. In one embodiment, this determination may be made based upon a number of factors, including one or more of a rank of the card, the probability of the card contributing to a winning player hand, etc.

In one embodiment, the BUY or SELL option is based on a change in an expected value for the player hand in relation to a wager and any portion of a dealer hand exposed to the player. A total hand expected value may be determined by an average winning amount based on simulations of possible outcomes using a player's initial hand and the portion of the dealer hand exposed to the player. The expected value for each individual card may be determined by an average winning amount based on simulations of possible outcomes using the player's initial hand with the individual card replaced and any portion of the dealer hand exposed to the player.

The BUY or SELL option for each card may be determined based on the difference between the total hand expected value and the individual card expected value for each card. The BUY value and the SELL for replacing each card may also be determined by the difference between the total hand expected value and the individual card expected value for each card plus any desired margin or house edge.

The buy/sell feature of the invention has the advantage of increasing the stakes and strategy associated with the game, and thus player excitement associated with the game.

Further objects, features, and advantages of the present invention over the prior art will become apparent from the detailed description of the drawings which follows, when considered with the attached figures.

### BRIEF DESCRIPTION OF THE DRAWINGS

FIG. 1 illustrates a gaming machine in accordance with one embodiment of the invention;

FIGS. 2A-2D show a flow chart which illustrates one embodiment of a method of the invention;

FIGS. 3A-3C illustrate one example of game play in accordance with a method of the invention; and

FIGS. 4A-4F illustrated another example of game play in accordance with a method of the invention.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games, gaming machines and gaming systems. In a preferred embodiment, the methods of game play and presentation are implemented via a gaming device or gaming system. Such a gaming device might comprise a gaming machine or gaming table which may have various configurations.

A gaming machine may be located at a casino (and as such may be referred to as a “casino gaming machine”). As described below, such a gaming machine may be part of a gaming system, such as a casino gaming system which links two or more of the gaming machines or one or more gaming machines with other devices, such as one or more gaming tables, kiosks, accounting systems or servers, progressive systems or servers, player tracking systems or servers or the like.

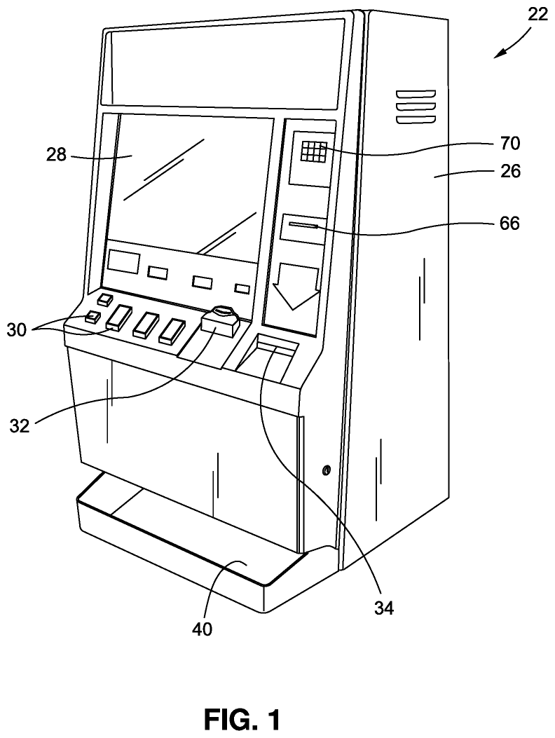

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be bought or sold, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising dealt cards, as detailed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 22 may also include one or more random number generators for generating random numbers (such as implemented by a random number generator software module stored in the memory and executable by the processor or controller), such as for use in selecting cards or other game symbols and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button (such as one of the buttons 30). Upon such an event and/or the player otherwise signaling the gaming machine to present the game, the controller may be configured to cause the at least one display 28 to display unique information, such as a unique graphical interface or unique game display, including game symbols or other game information (such as graphically represented images of cards, slot symbols, dice, etc.). The controller may accept input from a player of game inputs, such as a request to spin reels or the like, via the one or more player input devices of the gaming machine 22. As indicated above, the machine-readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server-based device and obtain game code or game outcome information from a remote game server (in which event the gaming machine controller may receive game information from the server, such as game outcome information, and use that server-generated information to present the game at the gaming machine). For example, the gaming machine 22 might be configured as a stand-alone device or as a server-based device for presenting games as Class III games (as defined by the U.S. Indian Gaming Regulatory Act) or as a server-based device for presenting games as Class II games (as defined by the U.S. Indian Gaming Regulatory Act).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOB s, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button (such as implemented via one of the buttons 30) or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray 40. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

The gaming machine 22 may, as noted above, be part of a system which includes other devices. For example, the gaming machine 22 may communicate with one or more casino systems, such as a player tracking server or system, an accounting system or server, a ticketing system, a bonusing system, a tournament system, other gaming machines, and external devices. As noted below, features of the invention may also be implemented relative to gaming device which comprise gaming tables.

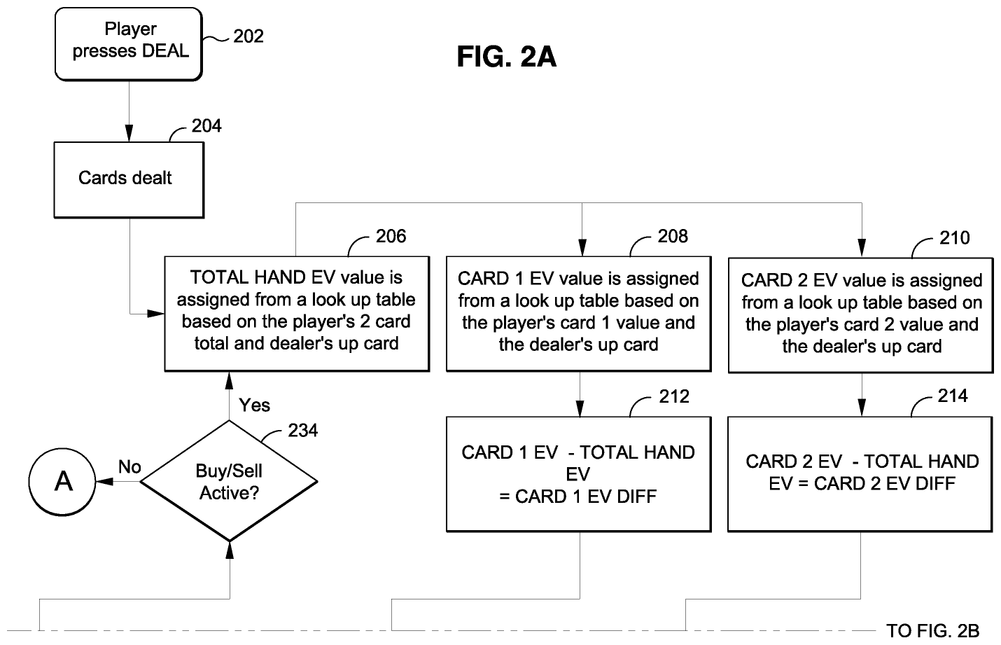

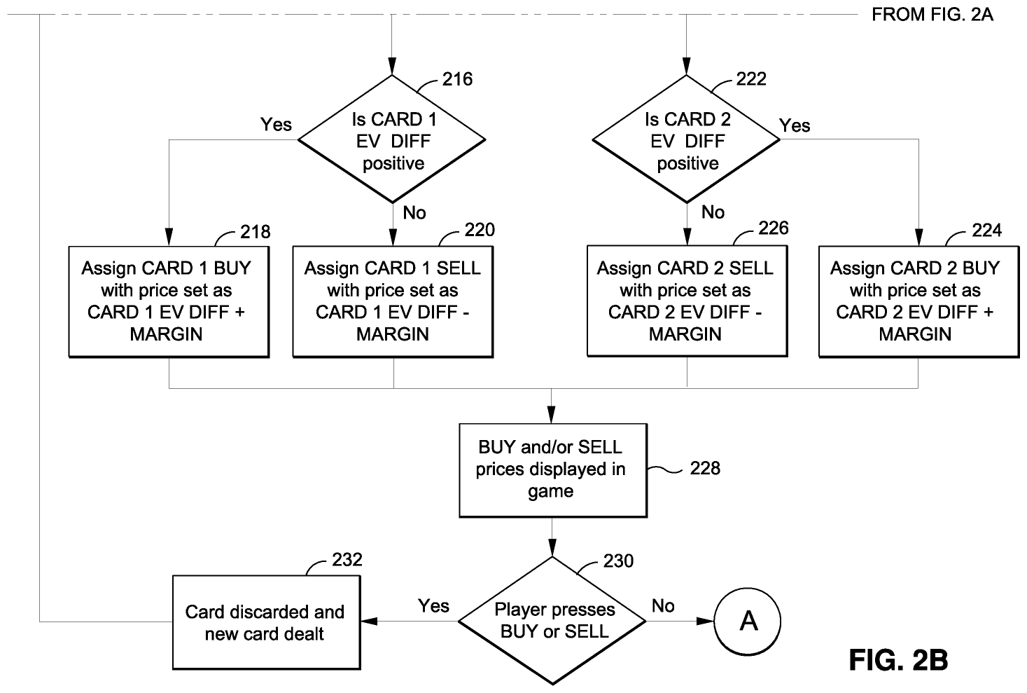

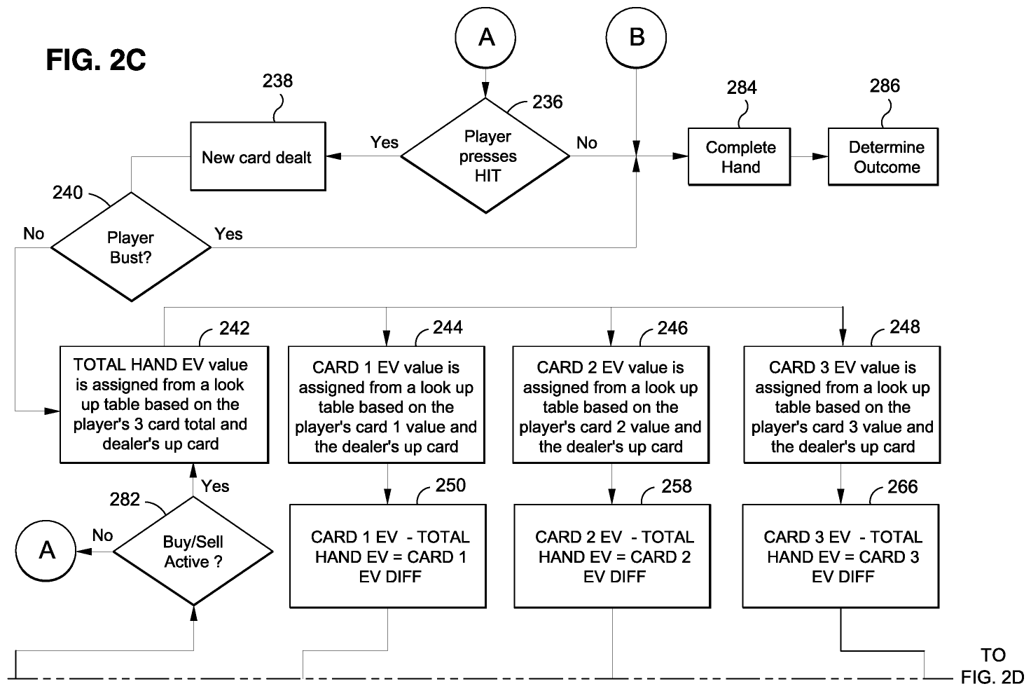

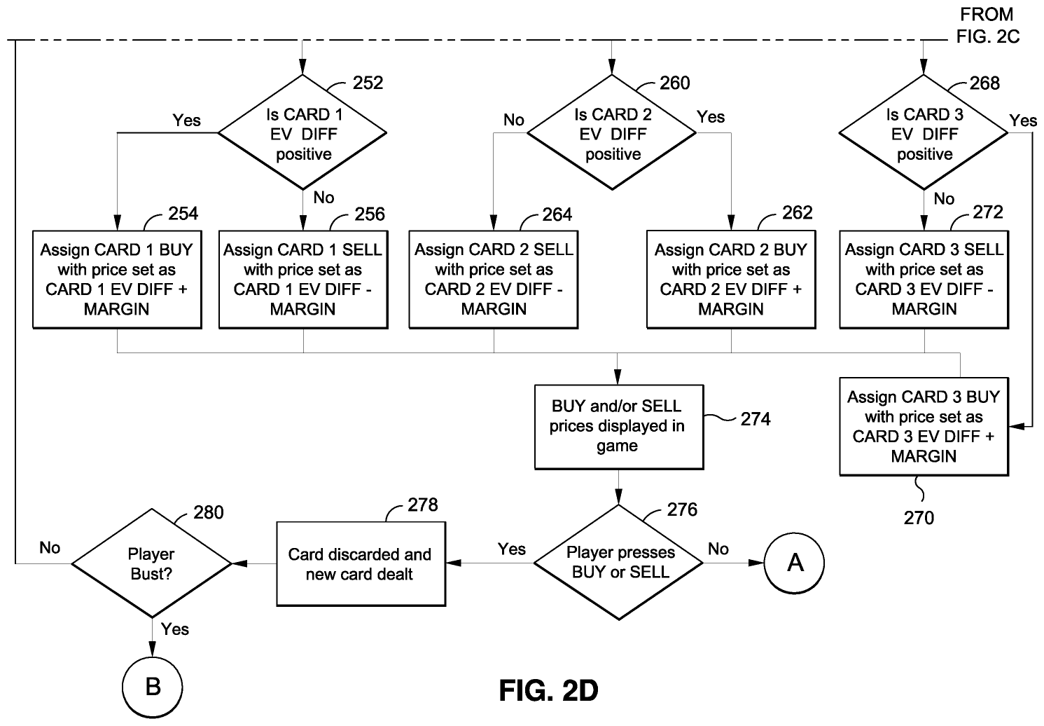

One embodiment of a method in accordance with an embodiment of the invention will be described with reference to FIGS. 2A-2D.

In a first step 202, a player places a wager via an input device and initiates a game, such as by pressing a DEAL button on a touchscreen, or the like. The amount of the wager may vary, and in one embodiment may be no less than a pre-set minimum amount such as $0.10, $0.25 or even $1 or $5. The wager might be placed as moneys, points, credits having monetary value or the like. As noted above, in one embodiment the wager may be placed from game credits, such as generated from monetary value which the player associated with a gaming machine.

In a step 204, one or more cards are dealt. The number of cards and how the cards are dealt may vary, such as depending upon the particular game which is being presented. For example, the method of the invention might be implemented relative to a poker type game or a blackjack game, among other types of games.

In a preferred embodiment, the method is implemented relative to a game of blackjack. In this embodiment, two cards are dealt to the player. As noted herein the cards may be dealt by presenting graphical images of the cards or by dealing physical cards. The cards might be dealt from a single deck of standard playing cards (having card values of A, 2 3, 4, 5, 6, 7, 8, 9, 10, J, Q, K in each of the four suits Hearts, Spades, Clubs and Diamonds), or from two or more of such decks. In one embodiment implemented via an electronic gaming device, the cards are dealt from an “infinite” deck of cards where each card dealt may be any card from those in a standard deck of playing cards, regardless of which cards have already been dealt. In a graphical embodiment, a random number generator or the like might be used to randomly select the cards from the one or more virtual decks. Physical cards might be dealt from one or more shuffled decks, such as from a card shoe. The cards dealt to each player are preferably dealt or displayed face up, but they might be dealt face down, or a combination thereof.

Preferably, two cards are also dealt or displayed to the dealer or house, one card face up and the other face down. In other embodiments, the dealer's or house's cards may be both dealt face up. Again, the cards might be physical cards or video images of cards or the like. These cards comprise an initial house or dealer hand.

Play may then proceed in a conventional manner, with the player electing a next action. This action may comprise, for example, standing, taking one or more cards (e.g. hits), making an insurance bet, or determining whether to split pairs, to double down, or surrender.

In one or more embodiments of the invention, a player may make an insurance bet if the dealer's face up card is an Ace. This bet is generally made after the player's and dealer's cards have been dealt, but before other cards have been dealt. In accordance with this bet, a player may wager an amount, such as one-half of their original wager or ante, as insurance against the dealer having a blackjack (i.e. two-card count of 21). If the dealer has a blackjack, unless the player also has a blackjack, the player loses on his original wager or ante, but is paid a winning at 2:1 on his insurance bet. In one embodiment, if the dealer has a blackjack, the game is over. The player loses on their original wager or ante unless the player also has a blackjack, in which event a push is declared, and those players are refunded their original wager or ante. If the dealer's hand is not a blackjack, then the player loses their insurance bet and then the game continues.

In one or more embodiments, a player may be permitted to surrender. In particular, in one embodiment of the game, a player may concede their hand, announcing a surrender and forfeiting some of their wager or ante, such as one-half of their wager. In one embodiment, a player is not permitted to surrender in the event the dealer has a blackjack.

In one or more embodiments, a player may be permitted to double down. If the player's first two cards have a predetermined count, such as 9, 10, or 11 (or in other embodiments, only 10 or 11, or only 11) then the player may be permitted to make a second wager equal to their first wager (i.e. double-down). The player is then dealt a single additional card, and the three cards then comprise the player's hand for purposes of determining if the player's hand is a winning hand or losing hand.

In one or more embodiments, a player may be permitted to split pairs. If the player's first two cards are a pair, then the player may be permitted to split the pair of cards, which each of the cards of the pair forming one card of each of two separate hands. The player's original wager or bet is applied to one of the hands, and the player is required to place a second wager to play the second hand. The player is dealt a second card for the two split hands, and then the two hands are treated just as single hands during the play of the game. For example, the player may stand or elect to take additional cards for either hand. In one embodiment, a player may be permitted to split a pair of Aces, but the player may be entitled to receive only a single additional card (i.e. form a two-card hand). An exception to this rule may be that if the player receives a second card which is an Ace, the player may be permitted to split the hands again, or may be permitted to receive additional cards for the hand, as desired.

In one embodiment, a player may be permitted to split pairs received on already split hands. For example, if a player splits a pair of Fours into a first hand and a second hand and then receives another Four in relation to either the first hand or second hand, the player may then split that hand, resulting in the player having three hands.

In one embodiment, a player may be permitted to double down on a split hand in similar manner to a conventional single hand. For example, if the player splits a pair of Sixes into a first hand and a second hand and then receives a Four with respect to one of the hands, the player may be permitted to double down and receive a single third card to form the three-card hand.

With respect to the player's hand (or hands, in the case of splits), the player may also stand or take one or more additional cards (e.g. hits, such as by indicating to a dealer at a table, or via input to a gaming machine).

Most importantly, as illustrated in FIGS. 2A-2D, the player may elect to BUY or SELL a card. In one embodiment of the invention, each card which is dealt to the player is assigned a BUY or SELL value or price. The BUY value or price is an amount which the player may elect to pay in order to discard the card and obtain a new replacement card. The SELL value or price is an amount which the player may elect to be paid in order to surrender the card and obtain a replacement card.

In one embodiment, the buy and sell values of the cards are based at least in part upon the worth of the card to the player's hand, and most preferably its value in forming a winning player hand, including taking into consideration the other cards of the player. For example, if the player is dealt an A♥ and 6♦, the A♥ intrinsically has a high value because if the 6♦ is discarded, any ten-count replacement card would cause the player's hand to result in a 21-count hand. On the other hand, the 6♦ has a lower value because very few card, in combination with that card, will result in a high card count hand (and thus a winning hand).

The buy or sell value of the card may be derived using an algorithm outlined in the steps below. It should be noted that in order to play the game in any meaningful way or at any meaningful pace, the steps of the algorithm to determine and present a buy or sell value are necessarily tied to and performed by the processor of the gaming machine or gaming device. For example, the processor of an electronic gaming machine performs the algorithm steps based on virtual cards dealt by the electronic gaming machine. In an example using physical playing cards, an electronic gaming device that senses or recognizes the cards dealt (such as by using a card reader or card scanner to detect or determine values thereof) may comprise a processor that performs the algorithm steps based on the detected physical cards dealt. Without the use of the electronic device, the play of the game would be impossible give the constant updating of buy sell values based on dealt cards as game play progresses. Thus, the following steps are necessarily tied to an electronic gaming device in some form, and a particular advantage of the invention thus comprises a system and device which are capable of real-time generation of card buy and sell values as the game is presented or played . . . .

In step 206, a total hand expected value (“EV”) is determined based on the player's wager, the player's two-card total, and the dealer's up card. The total hand EV may be a numeric value that represents a current strength of the hand. For instance, in one embodiment, the total hand EV represents an expected or average win value given the player's specific position (the player's cards and wager, and the dealer's up card). To illustrate, when a player bets $1 and is dealt a natural or blackjack hand (e.g. A [symbol] and K [symbol] ) and the dealer's up card indicates that the dealer cannot have a natural or blackjack hand (e.g. the dealer's up card is 2 [symbol] ), the total hand EV for the player's position is set to 1.5, because the player would be expected to win $1.50. The total hand EV may be calculated for any possible player position by running game play simulations on the player position to play out the position (such as by using the published best strategy for the player and normal dealer draw rules, or using other rules or criteria for playing out the player hand and the dealer hand). In one embodiment, the play simulations may be run thousands of times for each player position in order to generate reliable probabilities of outcomes and then those percentages may be applied to the winning and losing amounts based upon the player's wager in order to derive a monetary EV, or the hand simulations may be run with calculated winning and losing amounts and those amounts may be totaled up to create an average EV). The total hand EV is set based on the average win/loss based on all the possible simulations for the initial player position.

The total hand EV may be calculated by a processor of the gaming machine in step 206. In other embodiments, in order to decrease the amount of processing power needed at the gaming machine and/or the time to generate the EV as described herein, a total hand EV for each possible player position may be calculated in advance. For example, the EVs described herein may be determined in advance (such as by use of a separate gaming or computing device) to generate EV tables. The EV tables may then be stored on the memory of the gaming machine. The gaming machine may determine the total hand EV in step 206 by referring to a total hand EV lookup table based on the player's initial position. Such tables may include total hand EVs and individual card EVs, relative to the entire permutation of potential player positions (for example, the total hand EV table would include EVs for a player position of Ace and King as compared to a dealer card of 2, then Ace and King as compared to a dealer card of 3, and so on, whereby the gaming could simply compare the player's current position to the EV for that position as set forth in the table from among all possible positions, select the matching position and then the corresponding EV).

In step 208, an individual card EV is assigned to the player's first card. The individual card EV is calculated in similar fashion to the total hand EV by running simulations for each possible replacement of the player's first card and recording the average win/loss resulting from replacing the card. In this embodiment, to increase efficiency, the simulations for each combination may be done in advance, and the individual card EV for the player's first card may be determined from a lookup table for replacing the player's first card in light of the player's second card and the dealer's up card. Similarly, in step 210, an individual card EV is assigned for the player's second card in light of the player's first card and the dealer's up card, which may also be accomplished via a look-up table for efficiency. To determine whether the player's first and second cards are to be assigned a buy or a sell value, the processor subtracts the total hand EV from the first card EV in step 212 and subtracts the total hand EV from the second card EV in step 214. The results are stored as the Card 1 EV Difference and the Card 2 EV Difference, respectively.

In step 216, it is determined whether the Card 1 EV Difference is positive or negative. A positive Card 1 EV Difference means that replacing the player's first card is likely to increase the value of the hand in relation to the dealer's up card and thus increase the probabilities of a win. Therefore, the player's first card is assigned a buy value in step 218 when the Card 1 EV Difference is positive. In step 218, the price for buying a new card to replace the player's first card is calculated using the Card 1 EV Difference plus a predetermined margin. Alternatively, a negative Card 1 EV Difference means that replacing the player's first card is likely to decrease the value of the hand in relation to the dealer's up card and thus decrease the probabilities of a win. Therefore, in step 220, when the Card 1 EV Difference is negative, a sell value is assigned using the Card 1 EV Difference and subtracting the predetermined margin.

The predetermined margin may be set to any percentage value as desired by a game operator or supplier which may then be scaled to the wager placed by the player. For a buy value, the cost is increased by the percentage or margin. For a sell value, the sell price is reduced by the percentage or margin. For example, if the calculated price for buying a new card is $1.00, and the predetermined margin is 5%, then the price for buying a new card is set to $1.05. Similarly, if a calculated sell price for selling a card for a replacement card is $1.00 and the predetermined margin is 5%, then the price for selling the card is $0.95.

Similar steps are completed for the player's second card. In step 222, it is determined whether the Card 2 EV Difference is positive or negative. A positive Card 2 EV Difference means that replacing the player's second card is likely to increase the value of the hand in relation to the dealer's up card and thus increase the probabilities of a win. Therefore, the player's second card is assigned a buy value in step 224 when the Card 2 EV Difference is positive. In step 224, the price for buying a new card to replace the player's first card is calculated using the Card 2 EV Difference plus the predetermined margin. Alternatively, a negative Card 2 EV Difference means that replacing the player's second card is likely to decrease the value of the hand in relation to the dealer's up card and thus decrease the probabilities of a win. Therefore in step 226, when the Card 2 EV Difference is negative, a sell value is assigned using the Card 2 EV Difference and subtracting the predetermined margin.

Once a buy or a sell value has been calculated for each of the first and second cards in the player's hand, the values are displayed on an electronic gaming machine display in step 228. In step 230, the player elects via a player input device to buy or sell one of the cards based on the displayed values. If the player elects to buy or sell one of the cards, the indicated card to be sold or bought is discarded and a new card is dealt to replace it, and the requisite value is exchanged in step 232. In other words, if the player elects to BUY a card, the player may be required to pay value, such as from their credit balance to the house. If the player elects to SELL a card, the player may be paid value, such as by being paid credits to their credit balance. After the buy or sell card is replaced, the method proceeds to step 234. If the player does not elect to buy or sell one of the cards, the method proceeds to step 236.

If the card buy/sell feature is still active in step 234, this process may return back to step 206 where a new Total Hand EV is calculated based on the player's 2 card total (including the replacement card as a result of the buy or sell) and the dealer's up card. As noted above, the card buy or sell feature might only be available a certain number of times or during a particular time interval. When the card buy or sell feature is no longer active, the method proceeds to step 236.

In step 236, the player has the option to hit to receive additional cards for the player hand, in accordance with typical Blackjack play. If the player does not hit and elects to stand on the cards previously dealt, the method proceeds to step 284. When the player elects to hit, the method proceeds to step 238 where a new card is dealt to the player. If the new card causes the player's hand to bust in step 240, then the method proceeds to step 284. If not, the method proceeds to step 242.

In step 242, similar to step 206, a Total Hand EV is assigned to the player hand from a lookup table based on the player's three-card total and the dealer's up card. A card 1, 2, and 3 EV value is assigned for each of the player's cards from a look up table based on the card value and the dealer's up card in steps 244, 246, and 248. A Card 1 EV Difference is calculated by subtracting the total hand value from the Card 1 EV in step 250. When the Card 1 EV Difference is positive in step 252, then a buy value is assigned to the player's first card with the price set as the Card 1 EV Difference plus the calculated margin in step 254. When the Card 1 EV Difference is negative in step 252, then a sell value is assigned to the player's first card with the price set as the Card 1 EV Difference minus the calculated margin in step 256.

Values are similarly calculated for the player's second and third cards. Specifically, a Card 2 EV Difference is calculated by subtracting the total hand value from the Card 2 EV in step 258. When the Card 2 EV Difference is positive in step 260, then a buy value is assigned to the player's second card with the price set as the Card 2 EV Difference plus the calculated margin in step 262. When the Card 2 EV Difference is negative in step 260, then a sell value is assigned to the player's second card with the price set as the Card 2 EV Difference minus the calculated margin in step 264.

Similarly, a Card 3 EV Difference is calculated by subtracting the total hand value from the Card 3 EV in step 266. When the Card 3 EV Difference is positive in step 268, then a buy value is assigned to the player's third card with the price set as the Card 3 EV Difference plus the calculated margin in step 270. When the Card 3 EV Difference is negative in step 268, then a sell value is assigned to the player's third card with the price set as the Card 3 EV Difference minus the calculated margin in step 272.

Once a buy or a sell value has been calculated for each of the first, second, and third cards in the player's hand, the values are displayed on an electronic gaming machine display in step 274. In step 276, the player elects via a player input device to buy or sell one of the cards based on the displayed values. If the player elects to buy or sell one of the cards, the indicated card to be sold or bought is discarded and a new card is dealt to replace it, and the requisite value is exchanged in step 278. In other words, if the player elects to buy a card, the player may be required to pay value, such as from their credit balance to the house. If the player elects to sell a card, the player may be paid value, such as by being paid credits to their credit balance. Once the buy or sell card is replaced with a new dealt card, the method proceeds to step 280. If the player does not elect to buy or sell one of the cards, the method returns to step 236.

In step 280, the electronic gaming device determines whether the replaced card has caused the player hand to bust. If so, the method proceeds to step 284. If the player hand does not bust, then the method proceeds to step 282. If the card buy/sell feature is still active in step 282, this process may return back to step 242 where a new Total Hand EV is calculated based on the player's 3-card total (including the replacement card as a result of the buy or sell) and the dealer's up card. As noted above, the card buy or sell feature might only be available a certain number of times or during a particular time interval. When the card buy or sell feature is no longer active, the method proceeds to step 236.

It is noted that this process may repeat as the player accumulates more cards and may be repeated for a player hand having four cards, five cards, etc. When the player hand busts or the player elects to stand on the cards dealt, the method proceeds to step 284. In step 284 the player and dealer hands are completed as necessary according to game rules. This may comprise, for example, the player finishing their blackjack hand. As indicated above, this may comprise the player standing on the cards which are in the player's hand, “hitting” and taking one or more additional cards when the buy/sell feature is no longer active, etc.

Likewise, in this step the dealer's hand may be completed, for example when the player hand is not a bust. Generally, the treatment of the house or dealer hand is in accordance with predetermined rules. In accordance with conventional rules, the dealer must generally take additional cards if the dealer's card count is less than 17 (i.e. 16 or less). If upon taking additional cards the dealer's hand exceeds a card count of 21, then the dealer's hand is a losing hand and the player's hand (or hands) is declared a winning hand.

In one embodiment of the game, an exception to the above-stated rule may be that the dealer must take additional cards when the dealer's hand is a soft 17. By soft it is meant that the dealer has received a card count of 17 comprising an Ace and one or more other cards totaling a count of six.

If the player elects to receive additional cards at their turn, the dealer deals the additional cards. If the player's card count exceeds 21 at any time, then the player's hand is a losing hand and the player loses their wager. If the player's card count is less than 21 when they stand (i.e. stop taking additional cards) then the determination of whether the player's hand is a winning hand is made in accordance with the conventional rules of blackjack detailed below.

In a step 286, a game outcome determination may then be made. For example, in a game of blackjack, the outcome is determined by comparing the player's hand (or hands) with the dealer's hand after all cards have been dealt. If the player's hand is closer to a card count of 21 than the dealer's, without going over 21, then the player's hand is declared a winning hand. If the count of the player's hand and the dealer's hand are the same, then a push is declared. The game is ended for that player and the player's wager is returned.

In one embodiment, if a player's hand is a winning hand and is other than a blackjack (i.e. other than a two card 21, such as a three or greater card count of 21), then the player may be awarded winnings, such as a payout equal to the player's wager or bet, i.e. at 1:1.

In the event a player's hand is a blackjack (i.e. a two card hand with a count of 21—i.e. an Ace and any ten value card) and the dealer's hand is a blackjack, then in a preferred embodiment, a push is declared and the game is over and the player's wager or ante is returned. If the player's hand is a blackjack and the dealer's hand is not, then the player's hand is a winning blackjack hand. Preferably, the player is paid or awarded winnings, such as a payout of 1:1, 3:2, 6:5, or 2:1 of the player's wager.

Of course, the step of determining the outcome of the game may be different when the game being played is different. For example, relative to a game of poker, the outcome may be determined by comparing the player's final hand of cards to a table of winning hands to see if the player's final hand defines a winning poker hand, or by comparing the player's hand to the dealer's hand to see which hand has the highest poker rank.

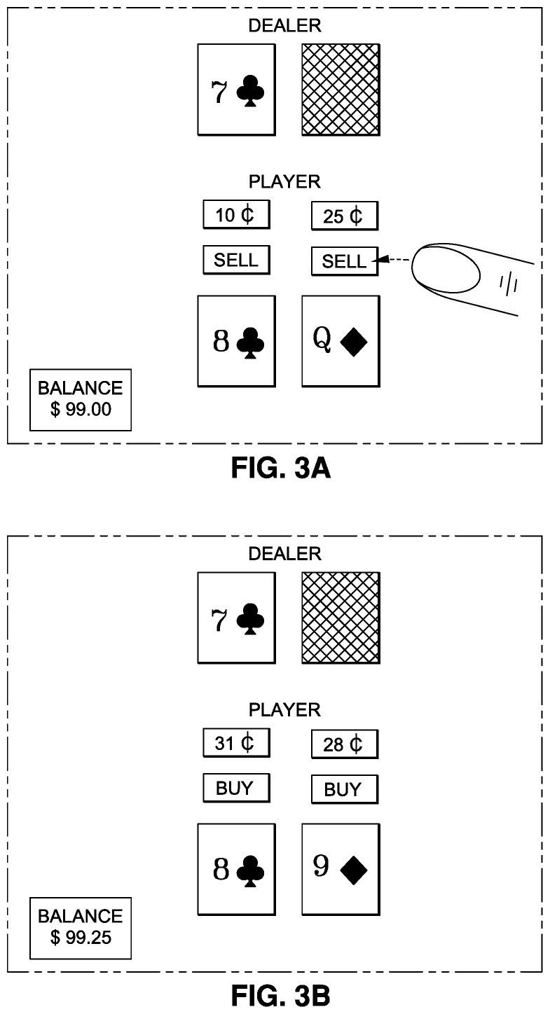

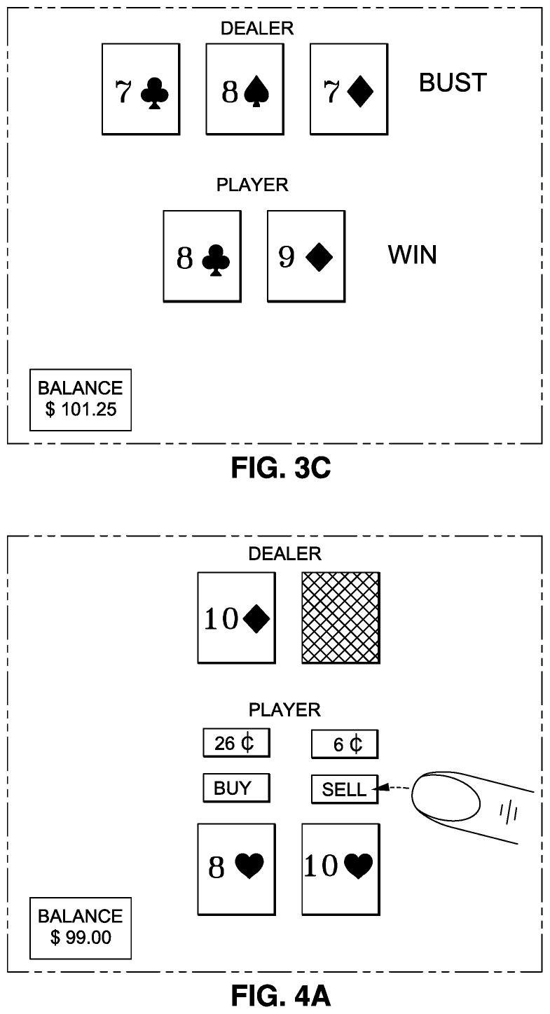

One example of the invention will be described with reference to FIGS. 3A-3C. In this example, the invention is implemented relative to a game of blackjack relative to a gaming machine such as that described above, wherein game information is displayed on a video display of the gaming machine. Assume in this case that the player started with a $100.00 balance and placed a required $1.00 wager, thus leaving the player with a $99.00 credit balance. As illustrated in FIG. 3A, at this point the dealer has been dealt two cards, a 7 [symbol] and a face down card. The player has been dealt the 8 [symbol] and the Q♦. In this case, the player has been given the option to SELL the 8 [symbol] for $0.10 and has been given the option to SELL the Q♦ for $0.25. As illustrated, value which has been assigned to each card and whether the value is to BUY or SELL the card is clearly displayed to the player relative to each card, such as graphically via a display of the gaming machine. In this example, the player has elected to SELL the Q♦, such as by selecting the SELL button above that card.

As illustrated in FIG. 3B, the player has thus been credited with a payment of $0.25, such that the player's credit balance is now $99.25. At the same time, a replacement card, the 9♦, has been dealt to the player's hand in replacement of the Q♦. Now the player is presented with the option to BUY a replacement card for the 8 [symbol] at a cost of $0.31 and BUY a replacement card for the 9♦ at a cost of $0.28. This example illustrates how the value of a card (the 8 [symbol] in this case) may vary over time, such as depending upon the other cards in the player's hand.

As illustrated in FIG. 3C, in this embodiment, the player has elected to stand on this hand (the 8 [symbol] and 9♦). As illustrated, the dealer's hand is then completed. The dealer has turned over their second card, which is the 8 [symbol] . Because the initial two dealer cards only total a count of 15 (a 7 and an 8), the dealer hand has been dealt an additional card per standard blackjack game rules. The dealer's hand was dealt the 7♦, causing the dealer's hand to bust with a count of 22. In this instance, the player's hand is a winning hand. In this example, the player was paid their original $1 wager plus $1 in winnings (paid at 1:1 odds in this example), making their credit total $101.25.

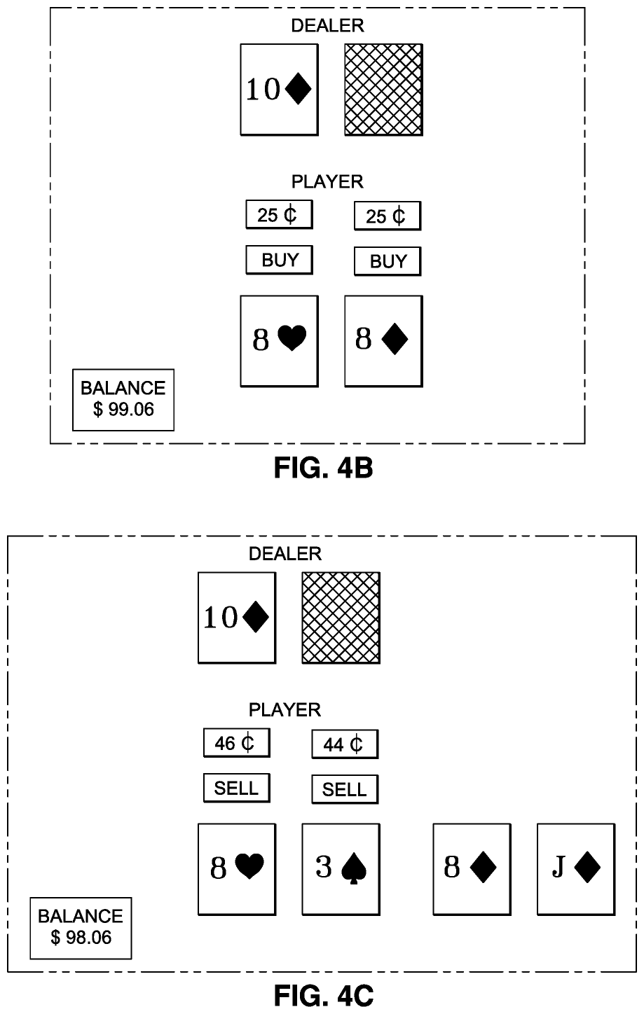

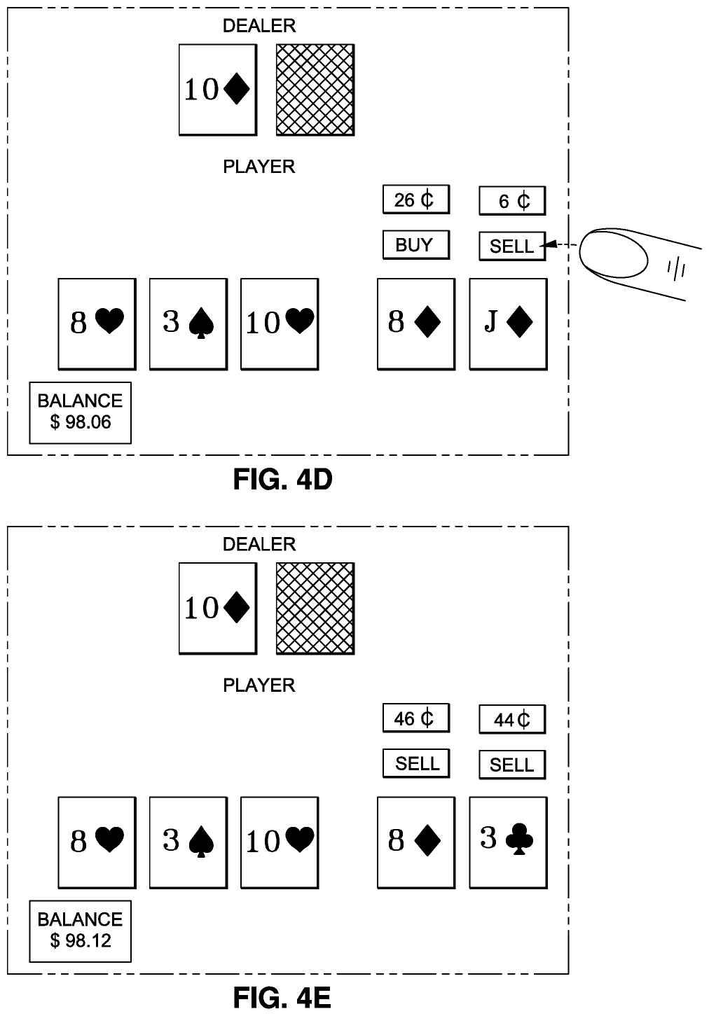

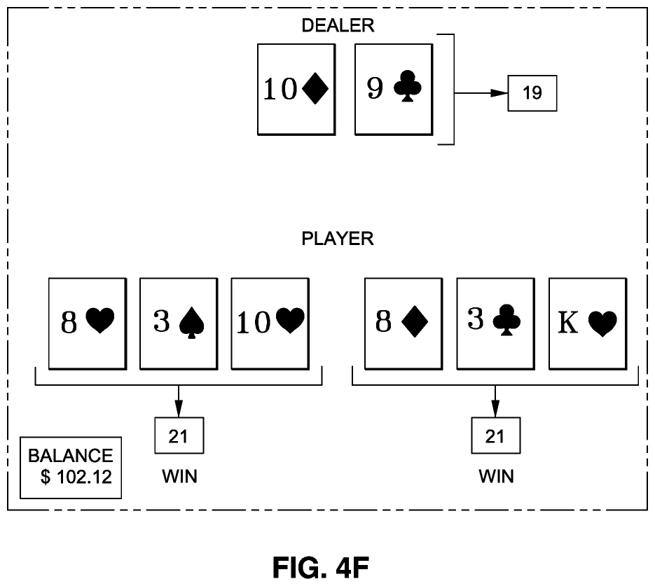

Another example of the invention is illustrated in FIGS. 4A-4F. In this example, the player again started with a $100.00 credit balance and placed a $1.00 wager to play the game. The dealer has been dealt an initial two card hand comprising the 10♦ and a face-down card. The player has been dealt an initial two card hand comprising the 8♥ and 10♥. Again, a BUY or SELL value has been assigned to each of the player's card. In this case, the 8♥ has been assigned a BUY option at a value of $0.26 and the 10♥ has been assigned a SELL option at a value of $0.06.

In the example illustrated in FIG. 4A, the player has elected to sell the 10♥. As a result, the player is paid $0.06 and the 10♥ is removed from the player's hand. As a result, as illustrated in FIG. 4B, the player's credit balance is now $99.06. Further, the player has been dealt a replacement card comprising the 8♦.

As illustrated, the 8♥ has been assigned a BUY option at a value of $0.25 and the 8♦ has also been assigned the same BUY option. In this case, however, as illustrated in FIG. 4C, the player has elected to “split” the hand into a first hand and a second hand. In order to split the hand into two hands, the player has paid a second hand wager of $1.00, causing the player's credit balance to decrease to $98.06. Further, cards are dealt to form a two card first hand and a two card second hand. As illustrated, the 3 [symbol] has been dealt to complete a first hand with the 8♥ and the J♦ has been dealt to complete a second hand with the 8♦.

Again, the player has been given the option to SELL the 8♥ for a price of $0.46, and has been given the option to SELL the 3 [symbol] for the price of $0.44. In this case, the player has elected to keep those cards and “hit” another card. As illustrated in FIG. 4D, an additional card, the 10♥ has been dealt to the first hand. The player has then elected to stand on those cards in the first hand.

The player is then given the option to BUY the 8♦ in the second hand for a price of $0.26 and to SELL the J♦ for a price of $0.06. In this case, the player has elected to sell the J♦. As a result, the player is paid $0.06 and the J♦ is replaced with another card. As illustrated in FIG. 4E, this has caused the player's credit balance to increase to $98.12 and the J♦ has been replaced with the 3 [symbol] . The player has then elected to “hit”. As illustrated in FIG. 4F, the player has been dealt the K♥ to their second hand, and as then elected to stand on those cards.

As illustrated in FIG. 4F, the dealer's hand is then finalized. In this case, the dealer's second card has been turned over to reveal the 9 [symbol] . The dealer's final hand thus has a 19 count. On the other hand, the player's first hand has a count of 21 and their second hand has a count of 21, such that both of the player's hands beat the dealer's hand. As a result, the player has been paid back their original wager and winnings at 1:1 odds for each of the split hands, whereby the final credit balance is $102.12.

Of course, the features of the invention may be implemented in various manners and relative to various different types of games, including poker games, baccarat and other games. While the buy/sell feature of the invention has been primarily described relative to card games and a card buy/sell feature, in one embodiment, the features of the invention may be implemented relative to other games using other types of game symbols, such as slot-type games where slot game symbols are utilized.

As noted, the invention may be implemented relative to an electronic game machine or in other manners, such as via a gaming table. As one example, the gaming table might comprise a pure electronic table which has a table surface and then features similar to the electronic gaming machine described above, such as a plurality of player stations each comprising a video display, player input devices, a monetary value accepting device and the like. The table may also include a dealer station. In this configuration, multiple players might play against a single dealer or house hand. Each player may be dealt a player hand which is displayed (graphically via the video display(s)) at their player station. The single dealer hand may be displayed to all players via a central display or via the individual player screens. BUY and SELL options and values may be displayed relative to each player's cards (wherein those values are separately calculated and displayed for each player and each card of that player's hand).

In yet another embodiment, the invention might be implemented relative to a game table at which physical playing cards are dealt by a dealer. In this embodiment, cards which are dealt may be scanned or read, such as via a card scanner. A processor might then use the scanned card information to calculate and display (such as at associated video screens at the table) card BUY and SELL values for each player's cards. Again, in this embodiment, while the game has the excitement of being played with physical cards, a technical solution is provided to obtaining the card data and automatically calculating card BUY or SELL options and associated values and providing those options in real time to the players.

As noted above, the BUY or SELL option might be provided to the player in various manners, such as via display of a BUY or SELL button or graphical element on a video display. In another embodiment, push-buttons or the like might be provided and which illuminate to indicate whether the BUY or SELL option is active and may be accepted by a player relative to a particular card or cards. In other embodiments, such as at a gaming table, the BUY or SELL option might be indicate directly to a dealer.

The invention has a number of advantages. One aspect of the invention is a card game where a player is given the option to BUY or SELL one or more cards in their hand. First, this feature raises the stakes in the game because it can result in the exchange of value between the player and dealer. The player may thus increase their credit balance or winnings by selling certain cards, or might pay to buy a card in hopes of obtaining a better or winning hand. One aspect of the invention is that a card may be assigned either a BUY or a SELL value, depending on circumstances such as its relative value to the hand. Thus, in some cases a player may be required to pay value to buy a new replacement card, but in others the player is actually paid to sell a card.

The buy and sell feature of the invention introduces additional strategy into the game beyond the base strategy. In particular, in some game like video poker a player may be permitted to discard a card. In this case, however, the player must also consider the cost associated with this option, such as whether the probability of obtaining a winning playing hand in view of cost of buying or selling a card.

One advantage to the invention is that the buy/sell option or feature can be implemented relative to games which are well known to a player and without changing the basic rules of those games. For example, as noted above, the buy/sell option may be implemented relative to a game of blackjack where the normal rules of blackjack still apply, including the rules for determining the outcome of the game.

One aspect of the invention is the automation of the buy and sell feature so that buy and sell options and associated values are calculated or provided in real time to the play of the game, such as by execution of a buy/sell algorithm executed by a processor associated with a gaming machine, game server or game table.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming device configured to present a game with a card buy/sell feature, comprising:
a monetary funds accepting mechanism for accepting monetary funds in creating a player credit balance;
at least one display device;
at least one player input device;
a memory device;
a controller; and
machine-readable code stored in said memory device and executable by said controller to
in response to a wager placed by said player from said player credit balance, cause said at least one display device to display an initial player hand of at least a first card and a second card;
generate in real time a value relative to each card of said initial player hand, the value relative to each card comprising a buy value or a sell value, and to cause said at least one display device to display a buy/sell option relative to each card of said initial player hand, wherein the buy/sell options comprise a first option to buy a card at the buy value and a second option to sell a card at the sell value;
accept input from said player via said at least one player input device of a selected buy/sell option;
debit or credit said player credit balance based upon said buy value or said sell value of said selected buy/sell option;
replace said card in said initial player hand associated with said selected buy/sell option;
finalize said player's hand; and
determine an outcome of said game with reference to said finalized player hand
wherein the value relative to each card is based on a comparison of a total hand expected value and an individual card expected value relative to each card, the total hand expected value being based upon an amount of the wager and an average payout of possible outcomes played out using the initial player hand, and the individual card expected value relative to each card being based on an average payout of possible outcomes played out using the initial player hand with each card replaced with all possible replacement cards.

2. The gaming device in accordance with claim 1 wherein said buy value of said first option to buy a card must be paid by said player.

3. The gaming device in accordance with claim 2 wherein said controller debits said player credit balance by reducing said player credit balance by said buy value which must be paid by said player.

4. The gaming device in accordance with claim 1 wherein said sell value said second option to sell a card is paid to said player.

5. The gaming device in accordance with claim 4 wherein said controller credits said player credit balance by increasing said player credit balance by said sell value which is paid to said player.

6. The gaming device in accordance with claim 1 wherein said game is a blackjack game and further comprising machine-readable code executable by said controller to cause said controller to deal a dealer hand and determine an outcome of said game with reference to said finalized player hand and said dealer hand.

7. The gaming device in accordance with claim 6 comprising finalizing said player's hand based upon said player electing to stand.

8. The gaming device in accordance with claim 6 comprising finalizing said player's hand by dealing one or more additional cards to said player.

9. The gaming machine in accordance with claim 8 further comprising machine-readable code executable by said controller to cause said controller to cause said at least one display device to display a buy/sell option relative to at least one of said additional cards.

10. The gaming device in accordance with claim 1 wherein said game is a poker game.

11. The gaming device in accordance with claim 1 wherein each possible total hand expected value and each possible individual card expected value is tabulated in an expected value look-up table stored in the memory device of the gaming device.

12. The gaming device in accordance with claim 1 wherein said input from said player of a selected buy/sell option comprising a selection of a displayed buy or sell icon displayed by said at least one display device.

13. The gaming device in accordance with claim 1 wherein said gaming device comprises a game table having a plurality of player stations.

14. The gaming device in accordance with claim 1 wherein said gaming device comprises a gaming machine having a cabinet.

15. The gaming device in accordance with claim 1 further comprising machine-readable code executable by said controller to cause said controller to award winnings to said player for a winning outcome of said game.

16. A gaming device configured to present a game with a card buy/sell feature, comprising:
a monetary funds accepting mechanism for accepting monetary funds in creating a player credit balance;
at least one display device;
at least one player input device;
a memory device;
a controller; and
machine-readable code stored in said memory device and executable by said controller to
in response to a wager placed by said player from said player credit balance, cause said at least one display device to display an initial player hand of at least a first card and a second card;
generate in real time a sell value relative to at least one card of said initial player hand, and to cause said at least one display device to display a sell option relative to the at least one card of said initial player hand, wherein the sell option comprises an option to sell a card at the sell value;
machine-readable code executable by said controller to cause said controller to accept input from said player via said at least one player input device of a selected sell option;
machine-readable code executable by said controller to cause said controller to adjust said player credit balance based upon said sell value of said selected sell option;
machine-readable code executable by said controller to cause said controller to replace said card in said initial player hand associated with said selected sell option;
machine-readable code executable by said controller to cause said controller to finalize said player's hand; and
machine-readable code executable by said controller to cause said controller to determine an outcome of said game with reference to said finalized player hand
wherein the sell value is based on a comparison of a total hand expected value and an individual card expected value relative to each card, the total hand expected value being based upon an amount of the wager and an average payout of possible outcomes played out using the initial player hand, and the individual card expected value relative to each card being based on an average payout of possible outcomes played out using the initial player hand with each card replaced with all possible replacement cards.

17. The gaming device in accordance with claim 17 wherein each possible total hand expected value and each possible individual card expected value is tabulated in an expected value look-up table stored in the memory device of the gaming device.
